(19) United States
(12) Patent Application Publication
(10) Pub. No.: US 2004/0224067 A1
(43) Pub. Date: Nov. 11, 2004

(54) Pelletized/extruded corn cob smoke flavoring product

(76) Inventor: John K. Burt, Grafton, NE (US)

Correspondence Address: LAW OFFICES OF ADAM H. JACOBS, SUITE 726, 1904 FARNAM STREET, OMAHA, NE, 68102, US

(21) Appl. No.: 10/840,762

(22) Filed: May 6, 2004

Related U.S. Application Data
(60) Provisional application No. 60/468,357, filed on May 6, 2003.

(51) Int. Cl. A23B 4/00

(52) U.S. Cl. 426/534

(57) ABSTRACT

A corn cob smoke flavoring product includes a quantity of finely ground corn cobs and a quantity of a flavoring material mixed with the quantity of finely ground corn cobs to form a generally homogenous corn cob/flavoring material mixture which is then processed through an extrusion process involving the cooking, grinding and mixing of the generally homogenous corn cob/flavoring material mixture under pressure and elevated temperature. Finally, the generally homogenous corn cob/flavoring material mixture is processed by a pelletizing process to form individual pieces of the generally homogenous corn cob/flavoring material mixture for burning to produce smoke for flavoring of grilled foods.

### CROSS-REFERENCE TO RELATED PROVISIONAL PATENT

This application claims priority based on a provisional patent, specifically on the Provisional Patent Application Ser. No. 60/468,357 filed May 6, 2003.

### BACKGROUND OF THE INVENTION

1. Technical Field

The present invention is related to smoking and flavoring products for meat products and, more particularly, to a pelletized corn cob material that is permeated with flavoring substances such as liquid smoke, liquid flavors, herbs or the like, which is then used as a smoking material in a food preparation apparatus to add the specified flavor to the food being cooked.

2. Description of the Prior Art

The cooking of meats and vegetables over an open fire predates virtually every other step of development of mankind, and, for example, it is known that the remnants of cooking fires have been found at a site called Terra Amata, an ancient beach location on the French Riviera, where stone hearths were found at the center of what may have been huts, with some sources putting the site's age at over 300,000 years old. Modern man has been blessed with many improvements over these original grilling techniques, and the popularity of barbecue cooking has skyrocketed with the advent of the propane barbecue grill over the older charcoal grill. The benefits of the propane grill are obvious, and include the fact that the cooking fire begins immediately and the grill reaches grilling temperature within a short time. Advocates of the charcoal grill, however, excuse the more temperamental and inconvenient nature of the charcoal grill in light of the increased flavoring potential for the grilled foods from the smoke emitted from the charcoal. Ideally, however, one would combine the smoke flavoring characteristics of the charcoal grill with the use benefits of the gas grill, and there is therefore a need for such a combination.

There are several different types of smoke producing devices which have been proposed in the prior art, including Orsing, U.S. Pat. No. 4,095,957, Holmes, U.S. Pat. No. 4,941,889 and Cofer, U.S. Pat. No. 5,048,406. The Orsing invention, for example, is a combustible fuel element for use in barbecue grills such as charcoal, coal, wood chips and coke, which are impregnated with a combustible fluid to aid in igniting the fuel. The Orsing invention, however, is not designed for use in a gas grill, although it could conceivably be modified for use therein.

The Holmes invention consists of wood chips bound together by a hard gelatin in water solution, which may include added flavorings to enhance the natural smoke flavor of the wood. These are then placed directly into the barbecue grill fire and produce smoke as the hard gelatin coating melts. Unfortunately, the melting of the coating would likely clog the gas jets of the gas grill should the Holmes invention be used in a gas grill, and thus the Holmes invention is not intended for use in a gas grill either.

Finally, the Cofer device is designed as a cylindrical cartridge containing wood chips. The cartridge may be partially opened on one side by a pull-tab ring to allow smoke to escape, or may have small perforations on one end of its top or side walls for the same purpose. The cartridge may also have small perforations on one end of its bottom wall to provide for draft ventilation. Cofer touts as a further advantage of the invention the fact that the wood chips need not be presoaked to prevent their catching on fire. In addition, Cofer states that if the device catches fire it can be readily blown out or doused by splashing with water, although it is difficult to see how water could be splashed onto the fire inside a device having such small access holes.

While each of these inventions has inherent advantages, they all offer only partial solutions to the problem of smoke generation within a gas grill, although the best of the lot appears to be the Cofer device. The Cofer device, however, uses wood chips, which are not of uniform size and consistency and which therefore produce uneven amounts of smoke during the burning process. While a large number of wood chips can average out to produce a consistent smoke, with a small amount of wood chips such as that found in the Cofer device, it is likely that there will be a significant difference between amounts and consistency of smoke produced by different produced examples of the Cofer invention. There is therefore a need for a smoke producing device which is not made of wood chips and therefore will produce a more even and flavorful smoke during the burning process.

Various materials may be burned to produce smoke, but it is not the mere burning capability which makes a material acceptable for smoking and flavoring, but rather the material's retention and release of the flavoring and the ability of the material to be artificially enhanced (flavor-wise). There is therefore a need for the use of a smoke producing material which is relatively inexpensive to produce, burns in a generally consistent manner and which can be easily and efficiently artificially flavored.

Therefore, an object of the present invention is to provide an improved corn cob smoke flavoring product.

Another object of the present invention is to provide an improved corn cob smoke flavoring product which is formed of a pelletized ground corn cob material to which flavorings have been added.

Another object of the present invention is to provide an improved corn cob smoke flavoring product which includes corn cob sections and pieces which would be deposited into a grinding device which would finely grind the corn cobs into a fine-grain powder material, the ground corn cob material then being mixed with a liquid or solid flavoring material which will add a specifically desired flavor to the corn cob material to be released when the product is burned.

Another object of the present invention is to provide an improved corn cob smoke flavoring product which may be added directly to a fire or may be housed within a canister for smoke emission therefrom.

Finally, an object of the present invention is to provide an improved corn cob smoke flavoring product which is relatively simple to produce, burns efficiently and is safe and flavorful in use.

### SUMMARY OF THE INVENTION

The present invention provides a corn cob smoke flavoring product including a quantity of finely ground corn cobs and a quantity of a flavoring material mixed with the quantity of finely ground corn cobs to form a generally homogenous corn cob/flavoring material mixture of the quantity of a flavoring material and the quantity of finely ground corn cobs. The generally homogenous corn cob/flavoring material mixture is then processed through an extrusion process involving the cooking, grinding and mixing of the generally homogenous corn cob/flavoring material mixture under pressure and elevated temperature, and finally the generally homogenous corn cob/flavoring material mixture is processed by a pelletizing process to form individual pieces of the generally homogenous corn cob/flavoring material mixture for burning to produce smoke for flavoring of grilled foods.

The present invention thus provides a substantial improvement over those products and methods found in the prior art. For example, the prior art teaches the use of wood products only, and it has been found that it is difficult if not impossible to evenly impregnate the wood chips with flavoring substances such that the burning of the wood chips results in a consistent, constant smoke flavoring output. Furthermore, the use of corn cobs in this manner creates a utility for a previously discarded by-product of the food industry, whereas the use of wood chips destroys a valuable resource, namely wood. Finally, it has been found that the resulting pelletized product of the present invention is much easier and safer to use than wood chips due to the splinters which come off of the wood chips and the uneven size and shape of the wood chips. The present invention thus provides a substantial improvement over those products and methods found in the prior art.

### BRIEF DESCRIPTION OF THE DRAWINGS

FIG. 1 is a detail side elevational view of the pelletized corn cob material of the present invention being used in a charcoal fire to provide additional flavoring to the meat product being grilled thereon;

FIG. 2 is a detail perspective view of one of the pelletized corn cob material products of the present invention; and

FIG. 3 is a detail perspective view of the pelletized corn cob material products of the present invention housed within a metal canister from which flavoring smoke is emitted into the grill interior for flavoring of meat being grilled therein.

### DESCRIPTION OF THE PREFERRED EMBODIMENT

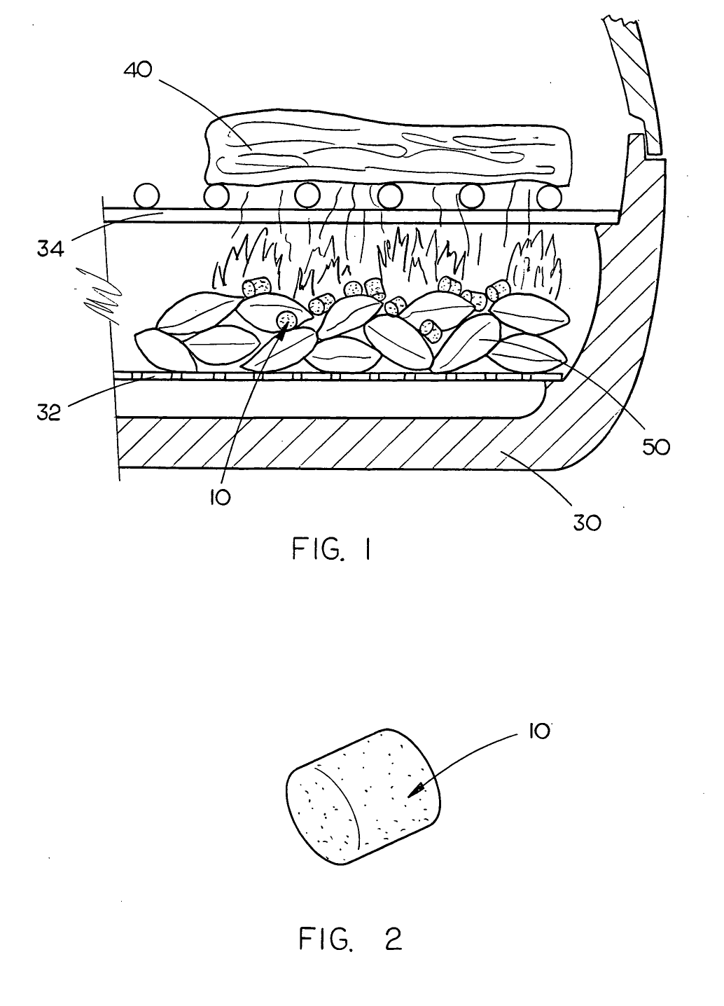

The corn cob flavoring product 10 of the present invention is shown best in FIGS. 1 and 2 as consisting chiefly of a pelletized ground corn cob material to which flavorings have been added. In the preferred embodiment, corn cob sections and pieces would be deposited into a grinding device which would finely grind the corn cobs into a fine-grain powder material. The ground corn cob material would then be mixed with a liquid or solid flavoring material which will add a specifically desired flavor to the corn cob material to be released when the product is burned. It should be noted that an almost unlimited number of different types of flavoring materials may be used with the present invention, including such flavorings as hickory or liquid smoke, Grand Marnier, cherry flavoring, teriyaki, soy, fruit flavoring, rum, maple, liquors or many other extracts and/or flavorings as desired by the user. It is preferred, however, that liquid-based flavorings be used for best permeation of the ground corn cob material. The mixture of the ground corn cob material and flavoring liquids or solids is then fed into an extruding or pelletizing device which would involve the cooking of the mixture under pressure and elevated temperature, specifically feeding the mixture through a dry extruder which utilizes a screw-type device to create friction, thereby cooking, grinding, and mixing the mixture. Of course, it should be noted that there are many different types of extrusion devices presently used which will properly prepare the product of the present invention, such as adjustable jaw expanders and wet extruders, the substitution of which would be understood by one skilled in the art of production of such products. Therefore it should be understood that such a substitution, particularly in the exchange of an extruder for an expander, is made part of this disclosure and is contemplated by the inventor.

The resulting extruded mixture of ground corn cob material and flavorings is then passed into a pelletizing device which forms small (one quarter inch to one inch in diameter) cylindrical pellets out of the mixture. The pelletizing process is generally understood in the prior art and is used in connection with the present invention to provide an easy to handle and easy to burn final flavoring product. Of course, it should be noted that it may be possible to use either one of the extruder or the pelletizer to produce the product of the present invention, or, alternatively, any other mixing, grinding and forming devices known in the prior art may be used with the ground corn cob and flavoring mixture of the present invention so long as the intended objective of forming an easily handled and easily burned flavoring product is maintained.

Once the pelletized or extruded corn cob product 10 is manufactured, it would then be used to flavor meat products or other products to be grilled in the following manner. As shown best in FIG. 1, the grill 30 would generally include a lower grate 32 on which a plurality of charcoal briquettes 50 are resting. Mounted above the charcoal briquettes 50 is a grilling grate 34 atop of which would rest a meat product 40 or the like for grilling on the grill grate 34. The charcoal briquettes 50 would be ignited to begin the fire within the grill 30 and soon thereafter a plurality of the pelletized corn cob product 10 of the present invention would be liberally strewn over the charcoal briquettes. As the pellets 10 ignite, the corn cob product produces a large quantity of smoke which is flavored by the flavoring material which permeates the pelletized corn cob product 10, the flavored smoke surrounding the meat product 40 and imparting the flavor contained within the burning pelletized corn cob product 10 to the meat product 40. It is expected that the duration of the burn of the pelletized corn cob product 10 will be varied according to the size and shape of the pelletized product, although it is generally preferred that the pelletized corn cob product 10 have a burn time of approximately fifteen to forty-five minutes to ensure that the meat product 40 is properly flavored and that the emission of the flavored smoke will continue for the duration of the cooking process.

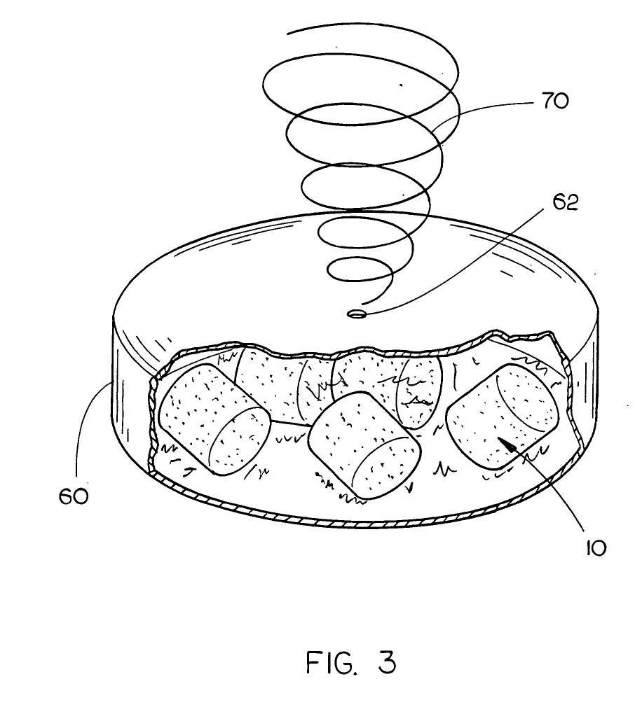

A minor modification in the use of the pelletized corn cob product 10 of the present invention is contemplated when the product is to be used with gas-type grills. In this case, the pelletized corn cob product 10 would be placed within a metal can 60 as shown in FIG. 3 which would keep the pelletized corn cob product 10 in a single location, thus eliminating the need for clean up of the pelletized product from the base of the gas grill should the pelletized product not be completely consumed in the cooking process. One or more small holes 62 formed in the top of the can will permit the flavored smoke 70 to be emitted therefrom as the pelletized corn cob product 10 held within the can is heated. It has been found that the use of the metal can 60 enclosed pelletized corn cob product 10 may actually result in increased flavored smoke emission, which is desirable when strong flavoring of the meat product 40 is desired.

It is to be understood that numerous modifications, additions, and substitutions may be made to the pelletized corn cob product 10 of the present invention which fall within the intended broad scope of the above disclosure. For example, the precise formation method used in creating the pelletized corn cob product is not critical to the present invention so long as the ground corn cob is perfused with the flavorings added thereto and then placed in an easily usable and easily burnable configuration. Also, the precise use characteristics of the present invention may be modified or changed depending on the flavoring desires of the user of the present invention. Finally, although the present invention has been described for use in connection with a charcoal grill or a gas grill, the present invention may be used in many different cooking situations, each of which would be understood by those skilled in the art of cooking.

There has therefore been shown and described a pelletized corn cob product with perfused flavoring material which accomplishes at least all of its intended objectives.

I claim:

1. A corn cob smoke flavoring product comprising:
a quantity of finely ground corn cobs;
a quantity of flavoring material mixed with said quantity of finely ground corn cobs to form a generally homogenous corn cob/flavoring material mixture of said quantity of a flavoring material and said quantity of finely ground corn cobs;
said generally homogenous corn cob/flavoring material mixture being processed through an extrusion process involving the cooking, grinding and mixing of said generally homogenous corn cob/flavoring material mixture under pressure and elevated temperature; and
said generally homogenous corn cob/flavoring material mixture being processed by a pelletizing process to form individual pieces of said generally homogenous corn cob/flavoring material mixture for burning to produce smoke for flavoring of grilled foods.

2. The corn cob smoke flavoring product of claim 1 wherein said quantity of flavoring material is selected from the group comprising hickory smoke, liquid smoke, Grand Marnier, cherry flavoring, teriyaki, soy, fruit flavoring, rum, maple, liquors and liquid smoke flavoring.

3. The corn cob smoke flavoring product of claim 1 wherein the ratio of said quantity of flavoring material to said quantity of finely ground corn cob material is between 1:1000 and 1:10.

4. The corn cob smoke flavoring product of claim 1 wherein said extrusion process uses a dry extruder which utilizes a screw-type device to create friction, thereby cooking, grinding, and mixing said generally homogenous corn cob/flavoring material mixture.

5. The corn cob smoke flavoring product of claim 1 wherein said pelletizing process uses a pelletizing device which forms generally uniform cylindrical pellets having a diameter of less than one inch (1″) from said generally homogenous corn cob/flavoring material mixture.

6. The corn cob smoke flavoring product of claim 1 wherein said individual pieces of said generally homogenous corn cob/flavoring material mixture are placed within a metal canister to retain said individual pieces in a single location, thereby eliminating the need for clean up of said generally homogenous corn cob/flavoring material mixture from the base of a gas grill, said metal canister further comprising at least one small diameter hole formed in a top portion of said metal canister operative to permit the flavored smoke to be emitted therefrom as said generally homogenous corn cob/flavoring material mixture held within said metal canister is heated.

7. A corn cob smoke flavoring product comprising:
a quantity of finely ground corn cobs;
a quantity of flavoring material mixed with said quantity of finely ground corn cobs to form a generally homogenous corn cob/flavoring material mixture of said quantity of a flavoring material and said quantity of finely ground corn cobs;
the ratio of said quantity of flavoring material to said quantity of finely ground corn cob material in said generally homogenous corn cob/flavoring material mixture being between 1:1000 and 1:10;
said generally homogenous corn cob/flavoring material mixture being processed through an extrusion process involving the cooking, grinding and mixing of said generally homogenous corn cob/flavoring material mixture under pressure and elevated temperature; and
said generally homogenous corn cob/flavoring material mixture being processed by a pelletizing process to form individual pieces of said generally homogenous corn cob/flavoring material mixture for burning to produce smoke for flavoring of grilled foods.

8. The corn cob smoke flavoring product of claim 7 wherein said quantity of flavoring material is selected from the group comprising hickory smoke, liquid smoke, Grand Marnier, cherry flavoring, teriyaki, soy, fruit flavoring, rum, maple, liquors and liquid smoke flavoring.

9. A corn cob smoke flavoring product comprising:
a quantity of finely ground corn cobs;
a quantity of flavoring material mixed with said quantity of finely ground corn cobs to form a generally homogenous corn cob/flavoring material mixture of said quantity of a flavoring material and said quantity of finely ground corn cobs;
said generally homogenous corn cob/flavoring material mixture being processed through an extrusion process involving the cooking, grinding and mixing of said generally homogenous corn cob/flavoring material mixture under pressure and elevated temperature;
said generally homogenous corn cob/flavoring material mixture being processed by a pelletizing process to form individual pieces of said generally homogenous corn cob/flavoring material mixture for burning to produce smoke for flavoring of grilled foods; and
said individual pieces of said generally homogenous corn cob/flavoring material mixture are placed within a metal canister to retain said individual pieces in a single location, thereby eliminating the need for clean up of said generally homogenous corn cob/flavoring material mixture from the base of a gas grill, said metal canister further comprising at least one small diameter hole formed in a top portion of said metal canister operative to permit the flavored smoke to be emitted therefrom as said generally homogenous corn cob/flavoring material mixture held within said metal canister is heated.

10. The corn cob smoke flavoring product of claim 9 wherein said quantity of flavoring material is selected from the group comprising hickory smoke, liquid smoke, Grand Marnier, cherry flavoring, teriyaki, soy, fruit flavoring, rum, maple, liquors and liquid smoke flavoring.
